(19) United States
(12) Patent Application Publication
(10) Pub. No.: US 2013/0166511 A1
(43) Pub. Date: Jun. 27, 2013

(54) DETERMINING AN OVERALL ASSESSMENT OF A LIKELIHOOD OF A BACKUP SET RESULTING IN A SUCCESSFUL RESTORE

(71) Applicants: Surya K. Ghatty, Rochester, MN (US); James P. Smith, Redwood City, CA (US); Peter B. Symonds, Portola Valley, CA (US); William R. Yonker, Rochester, MN (US)

(72) Inventors: Surya K. Ghatty, Rochester, MN (US); James P. Smith, Redwood City, CA (US); Peter B. Symonds, Portola Valley, CA (US); William R. Yonker, Rochester, MN (US)

(73) Assignee: INTERNATIONAL BUSINESS MACHINES CORPORATION, Armonk, NY (US)

(21) Appl. No.: 13/333,297

(22) Filed: Dec. 21, 2011

(51) Int. Cl. G06F 12/16; G06F 17/30

(52) U.S. Cl. 707/649; 707/E17.005

(57) ABSTRACT

A point-in-time backup image is selected from a plurality of backup images of an image on a source computer system to be applied to the target computer system. A first assessment value is associated with an extent to which critical files and recovery metadata are included in the selected backup based on an include list of critical files and recovery metadata to include in the backup. A second assessment value comprises a backup status of the critical files and the recovery metadata. A third assessment value is indicative of an extent to which the selected backup satisfies requirements of a retention policy. A fourth assessment value is indicative of an extent to which computational resources and device drivers in the target computer system are compatible. An overall assessment value for the selected backup image is determined based on the determined first, second, third, and fourth assessment values.

### BACKGROUND OF THE INVENTION

1. Field of the Invention

The present invention relates to a computer program product, system, and method for determining an overall assessment of a likelihood of a backup image resulting in a successful recovery.

2. Description of the Related Art

A storage management application, such as IBM* Tivoli* Storage Manager (TSM), may be implemented on a storage management server. The storage management application may manage storage requirements for a plurality of client nodes that are coupled to the storage management server via a network. (IBM and Tivoli are registered trademarks of International Business Machines Corp. in the United States and other countries).

The storage management application may create and manage a repository for backup images. A backup image stores files needed to recover a state of a machine, including the current operating state of the machine, data, programs, and configuration settings, that are backed up, archived, migrated, or otherwise copied from the client nodes to the storage management server. The recovery of a backup image at a client node allows the client to operate with the state of the machine represented in the image. The storage management server may store machine components, such as programs, files, configuration settings, in one or more storage pools and may use a database stored in the storage management server for tracking information about the stored machine components.

The storage management application may perform incremental backup, incremental archiving, migration, or incremental copying of images from the client nodes to the storage management server. For example, if the storage management application comprises a backup application then the backup application may perform incremental backup operations in which image components are backed up only if the files have changed since a previous, periodic full backup, where the periodic full backups may be made on a weekly, monthly or some other periodic basis.

A Bare Machine Recovery (BMR) is defined as the ability to execute a recovery operation on a computer without using the operating system that is currently loaded on the computer. BMRs are performed from full or incremental backups. However, a selected backup image may not be useful and may have problems or errors that will prevent a successful restoration.

There is a need in the art to assess the suitability of a selected backup image and the likelihood of success of a recovery operation using a selected backup image.

### SUMMARY

Provided are a computer program product, method, and system for assessing a backup image comprising a backup of a source computer system to recover to a target computer system. A point-in-time backup image is selected from a plurality of backup images in a computer readable storage taken of an image on the source computer system, wherein the selected backup is to be applied to the target computer system. A determination is made of a first assessment value associated with an extent to which critical files of the image from the source computer system and recovery metadata providing configuration information on the source computer system are included in the selected backup based on an include list of critical files and recovery metadata to include in the backup. A determination is made of a second assessment value comprising a backup status of the critical files and the recovery metadata included in the selected backup. A determination is made of a third assessment value indicative of an extent to which the selected backup satisfies requirements of a retention policy in effect when the backup images were created. A determination is made of a fourth assessment value indicative of an extent to which computational resources and device drivers in the target computer system are compatible with computational resources and device drivers on the source computer system. And, a determination is made of an overall assessment value for the selected backup image based on the determined first assessment value, second assessment value, third assessment value, and fourth assessment value. The information on the overall assessment value is presented for use in determining whether to apply the image stored in the selected backup image to the target computer system.

### BRIEF DESCRIPTION OF THE DRAWINGS

FIG. 1 illustrates an embodiment of a backup computing environment.

FIG. 2 illustrates an embodiment of a backup image.

FIG. 3 illustrates an embodiment of a backup image metadata.

FIG. 4 illustrates an embodiment of file metadata.

FIG. 5 illustrates an embodiment of an include list.

FIG. 6 illustrates an overview of operations to assess a backup image.

FIG. 7 illustrates an embodiment of operations to determine first assessment value based on files from an include list included in the selected backup-set

FIG. 8 illustrates an embodiment of operations to determine s second assessment value based on a backup status of backed-up files in the include list.

FIG. 9 illustrates an embodiment of operations to determine a third assessment value based on whether the backed-up files satisfy a retention policy.

FIG. 10 illustrates an embodiment of operations to determine a fourth assessment value based on a compatibility of device drivers and computational resources at the source and target computer systems.

FIG. 11 illustrates an embodiment of operations to determine an overall assessment value.

FIG. 12 illustrates an embodiment of a computing environment.

### DETAILED DESCRIPTION

Described embodiments provide techniques for assessing the likelihood that a selected backup image will result in a successful recovery operation based on a plurality of factors, such as whether the backup image includes critical files and recovery metadata, the backup status of those backed-up critical files and recovery metadata, whether the selected backup image satisfies a retention policy, and whether the target computer to which the image maintained in the backup image is applied has computational resources and device drivers compatible with those in the source computer from which the image was generated.

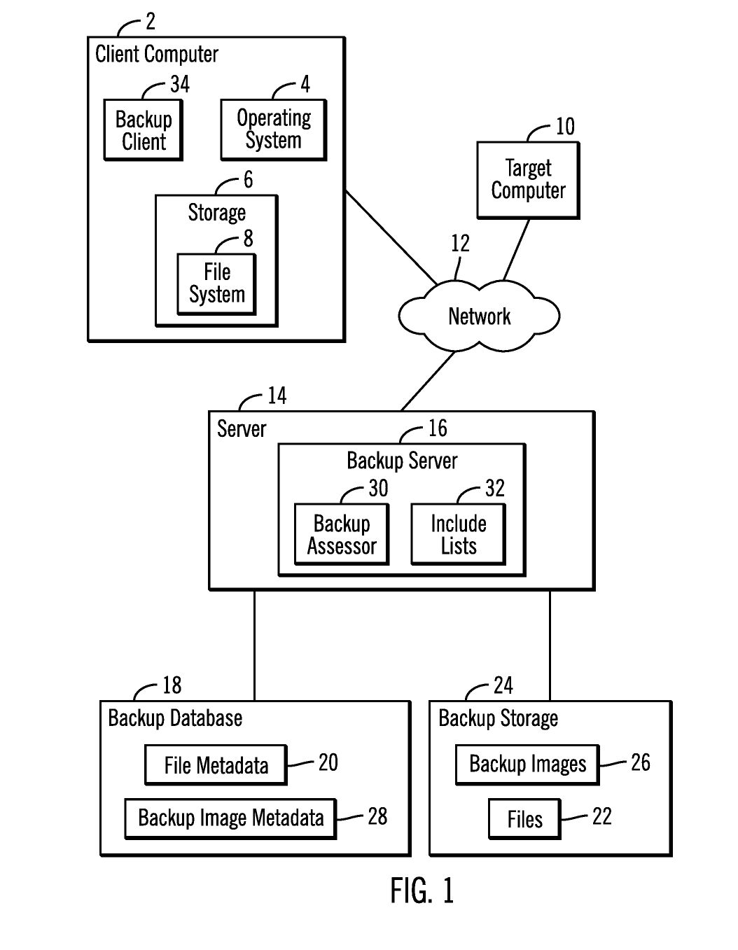

FIG. 1 illustrates an embodiment of a network computing environment. A client computer 2 comprises a computer system including an operating system 4, a storage 6, and a file system 8 having files, drivers, library files, programs, and data used by the client 2. One client computer may comprise a target computer 10 to which an image of the client computer 2, including the operating system 4 and file system 8, may be copied to replicate the client computer 2 at the target computer 10. There may be multiple client computers 2 in the network 12.

The client computers 2 and target computer 10 communicate with a server 14 over the network 12. The server 14 includes a backup server 16 program to backup or archive client files in the file system 8 and to create backup images of the client computer 2 system, including machine components such as the operating system 4 and file system 8, to allow the operating environment of the client computer 2 to be recovered to another target computer 10 or the client computer 2.

The backup server 16 stores in a backup database 18 file information 20 having information on client files 22 stored in a backup storage 24 that are stored separately in the backup storage 22 from any backup images 26 that may include the files 24. The backup server 16 maintains backup image metadata 28 in the backup database 18 having information on the backup images 26 in the backup storage 22. There is one instance of file metadata 20 and backup image metadata 28 for each file 22 and backup image 26, respectively, maintained for each client node. Each backup image 26 may provide an image of a client computer 2 as of a point-in-time, including files needed to recover a computer to a previous state. There may be multiple backup images 26 for one client computer 2, such that one of the backup images comprises a full backup of the client computer 2 image and other later taken backup images comprise incremental backups of the client computer 2 image, providing changes between the previous backup images and the current point-in-time of the incremental backup.

When restoring a computer as of a point-in-time from one of the backup images, the backup server 16 accesses most recent versions of files 22 indicated in the selected backup image, all previous incremental backup images, and the full backup image to recover. In a progressive incremental backup, if the client wants to recover a point-in-time, the backup server 16 is responsible for sorting out the files which would satisfy the desired point-in-time so that the client does not need to understand or select when the full and various incremental backups were taken.

The backup server 16 includes a backup assessor 30 component that assesses the likelihood of a successful recovery operation from a selected backup image 26 by considering various factors. The backup server 16 further maintains one or more include lists 32, where each include list 32 provides the critical files and recovery metadata that are required to be included in a backup image for a successful recovery operation.

The client 2 may further include a backup client 34 program to transfer copies of the client 2 image and client files in the client file system 8 over the network 12 to the backup server 6.

The client computers 2 and target computer 10 that communicate with the backup server 16 may comprise suitable computational devices known in the art, such as servers, desktop computers, workstations, mainframes, hand held computing devices, telephony devices, etc. There may be multiple instances of the client computer 2. The client storage 6 may comprise a primary storage device used by a client 2, such as one or more hard disk drives, solid state storage devices (SSDs), etc. The backup storage 24 may comprise storage comprise storage media implemented in one or more storage devices known in the art, such as interconnected hard disk drives (e.g., configured as a DASD, RAID, JBOD, etc.), solid state storage devices (e.g., EEPROM (Electrically Erasable Programmable Read-Only Memory), flash memory, flash disk, solid state storage devices (SSDs), storage-class memory (SCM)), electronic memory, magnetic tape media, tape cartridges, etc.

The network 12 may comprise a Wide Area Network (WAN), Local Area Network (LAN), Storage Area Network (SAN), wireless network, the Internet, an Intranet, peer-to-peer network, etc. The backup database 18 may comprise a relational database or other suitable database known in the art

The backup client 34 and backup server 6 may comprise programs included with a client-server backup program, such as the IBM™ Tivoli™ Storage Manager (TSM) backup manager or client-server backup programs offered by different computer vendors. Further, in certain embodiments, the client backup programs and backup server 16 may be implemented in the client machines so that the clients write backup images directly to the backup storage 24 without the need for the server 14.

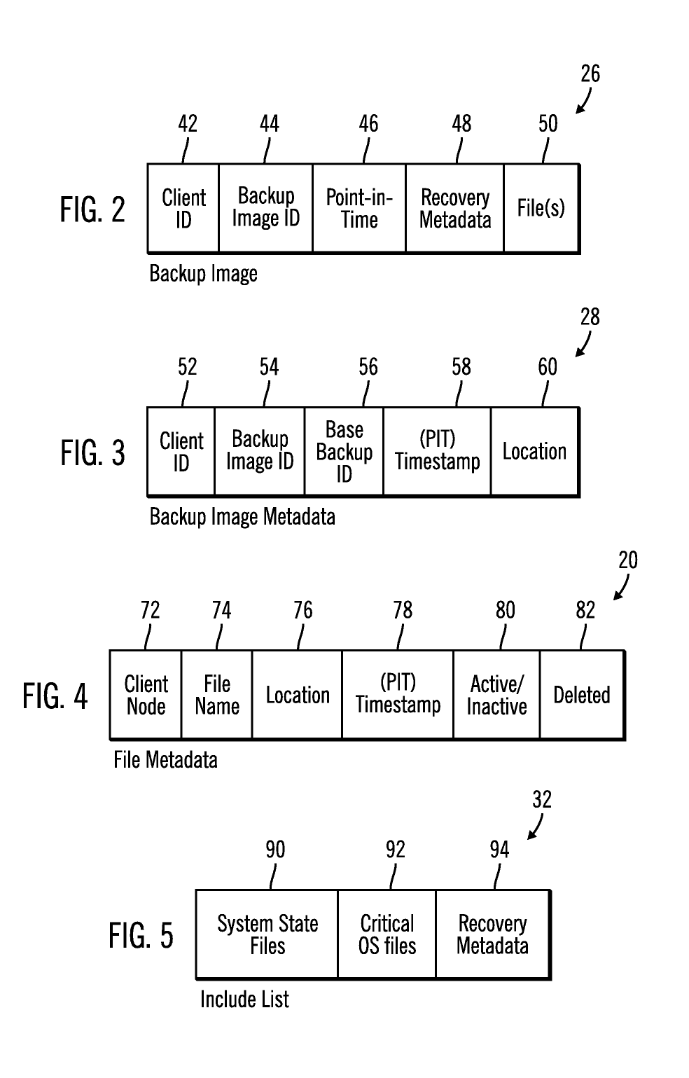

FIG. 2 illustrates an embodiment of an instance of one backup image 26 as including: client information 42 identifying the client whose image is included in the backup image 26; a backup image identifier (ID) 44; a point-in-time timestamp 46 of the date and time the backup image was created; recovery metadata 48 having information on the client computer 2 required to recover the image, such as the partition layout, storage required, machine hostnames, etc.; and information indicating the files 50 included in the backup image 20, such as a file identifier. In this way, the backup image 26 provides a definition of the files included in the image taken from the client computer 2.

FIG. 3 illustrates an embodiment of an instance of backup image metadata 28 maintained in the backup database 18 for each backup image 26, including: client ID information 52 identifying the client computer 2 whose image, e.g., operating system 4 and file system 8, is included in the backup image 26; a backup image identifier (ID) 54; a base backup image ID 56 identifying the backup image having the full backup of the client 52 if the backup image 54 is an incremental backup image for the full backup image; a point-in-time timestamp 58 of the date and time the backup image was created; and a location 60 of the backup image 24 in the backup storage 24.

FIG. 4 illustrates an embodiment of an instance of file metadata 20 maintained in the backup database 18 having information on a client file 22 stored external to the backup images. In this way, a client file 22 may be stored external in the backup storage 24 to any backup image 26 and indication of the file may be stored within a backup image 26. An instance of file metadata 26 may include: client information 72 identifying the client computer 2 from which the file originated; a file name 74; a location 76 of the file 22 in the backup storage 24; a point-in-time (PIT) timestamp 78 for the file when it was created or last modified; an active/inactive field 80 indicating whether the file is active or inactive; and a deleted field 82 indicating whether the file was deleted from the client 2.

FIG. 5 illustrates an embodiment of an include list 32 indicating critical files and recovery metadata that should be included in the backup image for a successful recovery operation, including system state files 90, such as files required by the operating system; critical operating system files 92 necessary to define the operating system 4 such that the target computer 10 on which the image is recovered may be booted and execute; and recovery metadata 94. The critical operating system files 92 indicated in the include lists 12 may be platform dependent, such that the files differ for different operating systems. The critical files 92 may further include critical user data. The recovery metadata 94 provides information about the source machine, such as the partition layout, file system definitions, backup connection information, hostnames, information on files, disk space, computational resources.

For instance, the critical files for a Microsoft® Windows® BMR operating system recovery would include the system state files such as the Registry, COM+ Class Registration database, Boot files, including the system files, Certificate Services database, Active Directory directory service, SYSVOL directory, Cluster service information, IIS Metadirectory, System files that are under Windows File Protection. Restoring the System State, along with the primary drive (e.g.: C:\) have been found to be sufficient for a Windows operating system recovery. (Microsoft and Windows are registered trademarks of Microsoft Corp. in the United States and foreign countries).

For UNIX platforms, the critical files may include the files in the file systems at the locations: /. /usr; /opt; /export/home; and /export/install. (UNIX is a trademark or registered trademark of The Open Group.).

Thus, different include lists 32 for different operating systems, different versions of similar operating systems or client images may be maintained.

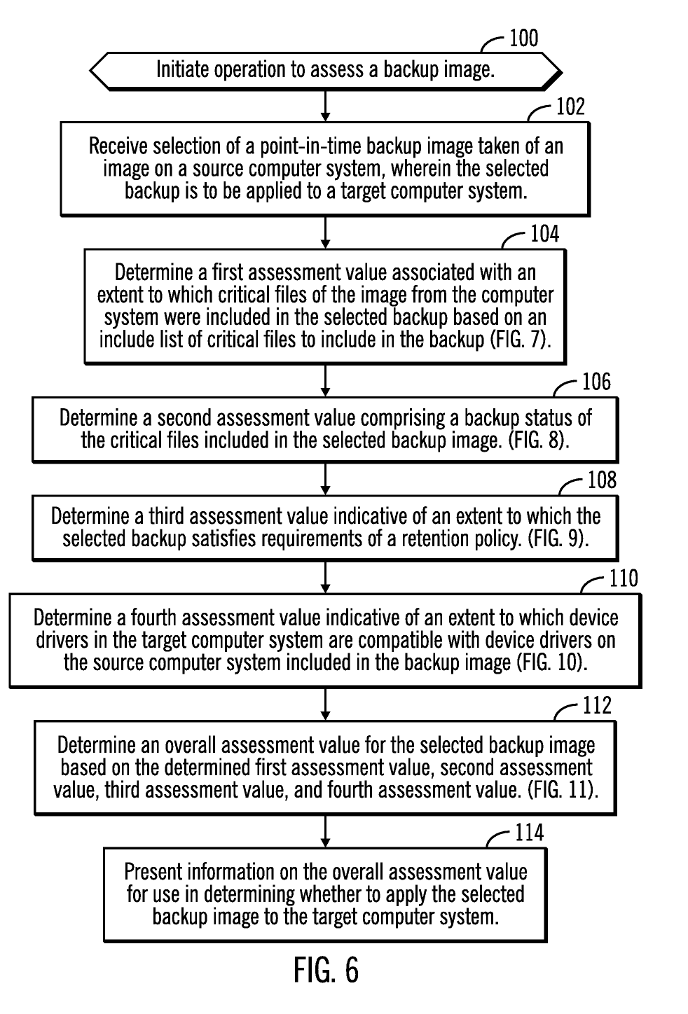

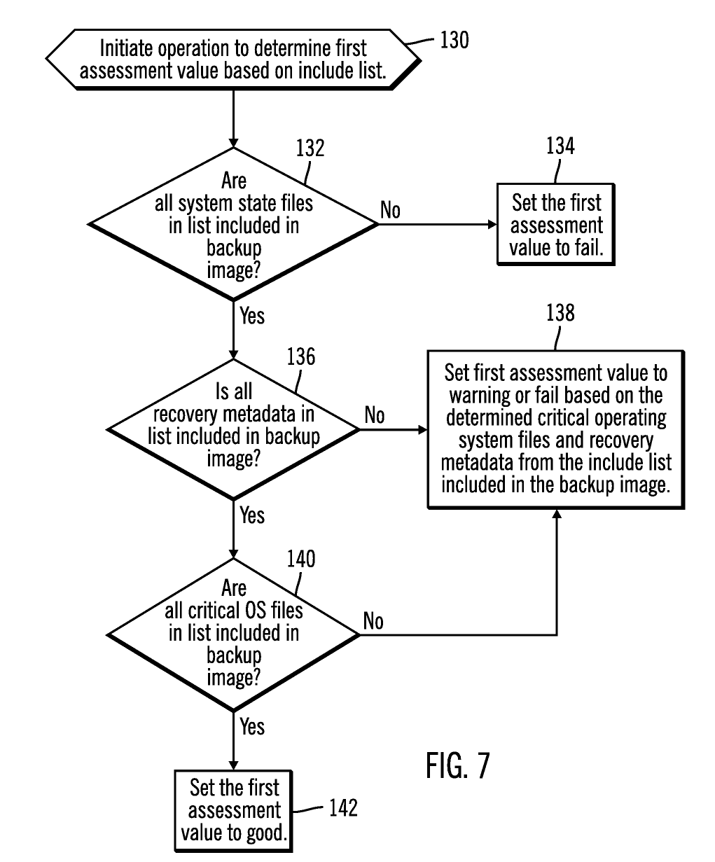

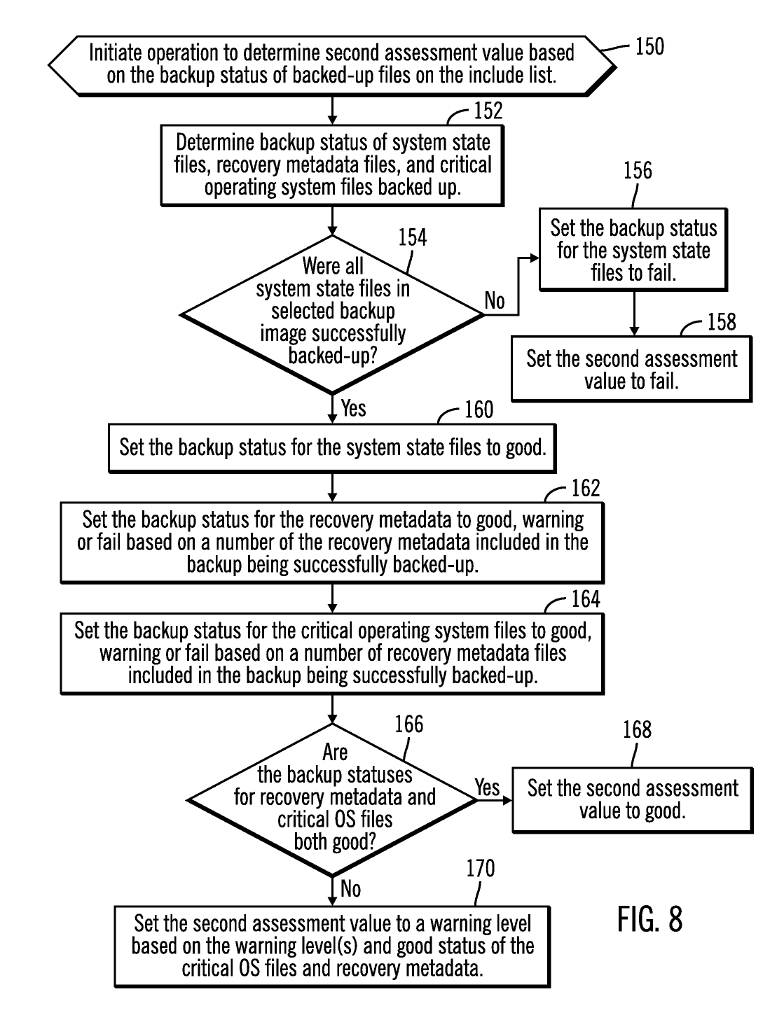

FIG. 6 illustrates an embodiment of operations performed by the backup assessor 30 to determine an assessment value or score describing the likelihood that a user selected backup image 26 will result in a successful recovery of an image of a client computer, including the operating system 4 and file system 8, to a target computer 10. Upon initiating the assessment operation (at block 100), the backup assessor 30 receives (at block 102) selection of a point-in-time backup image 26 taken of an image on a source computer system, comprising one of the client computer 2, wherein the selected backup is to be applied to a target computer system 10. The backup assessor 30 determines (at block 104) a first assessment value associated with an extent to which critical files and metadata of the image from the computer system were included in the selected backup image 26 based on the include list 32 relevant to the image being recovered. FIG. 7 provides further details on operations to determine the first assessment value. The backup assessor 30 determines (at block 106) a second assessment value comprising a backup status of the critical files and recovery metadata included in the selected backup image. FIG. 8 provides further details on operations to determine the second assessment value.

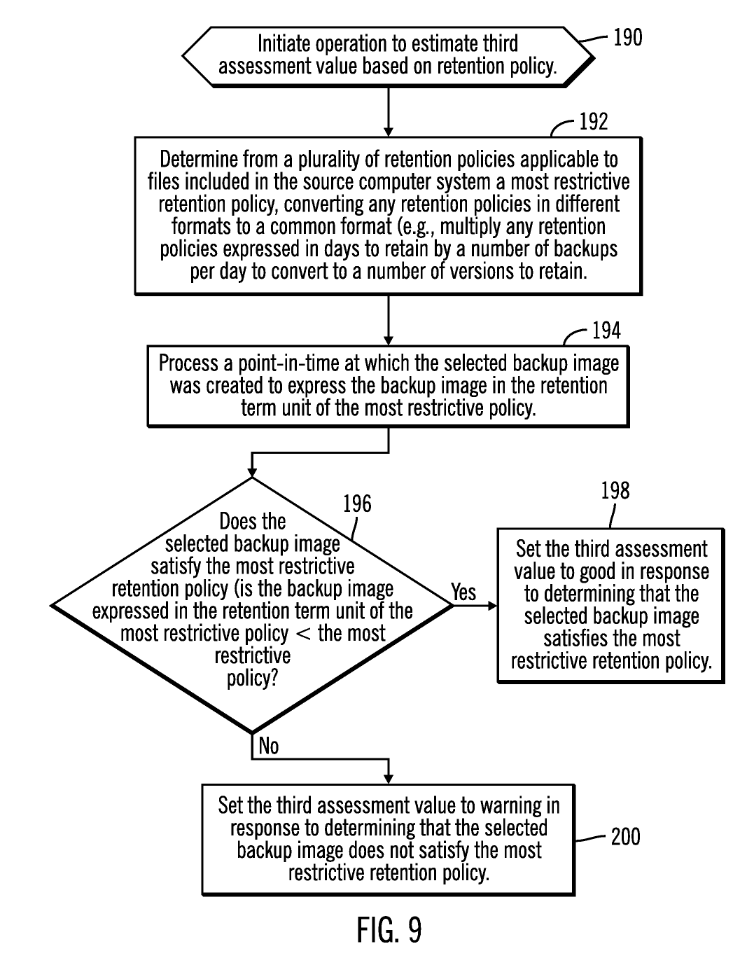

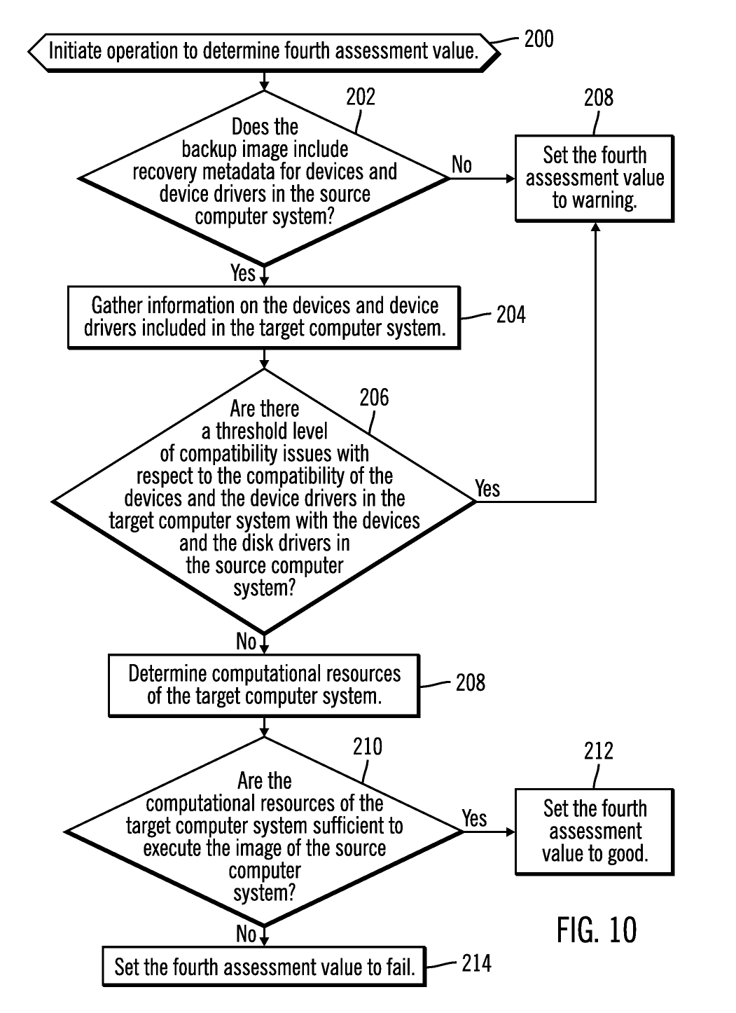

The backup assessor 30 determines (at block 108) a third assessment value indicative of an extent to which the selected backup image satisfies requirements of a retention policy, such as a current retention policy or retention policy in effect when the backup image was created. FIG. 9 provides further details on operations to determine the third assessment value. The backup assessor 30 further determines (at block 110) a fourth assessment value indicative of an extent to which device drivers in the target computer system 10 are compatible with device drivers on the source computer system whose image is represented in the backup image 26. FIG. 10 provides further details on operations to determine the fourth assessment value.

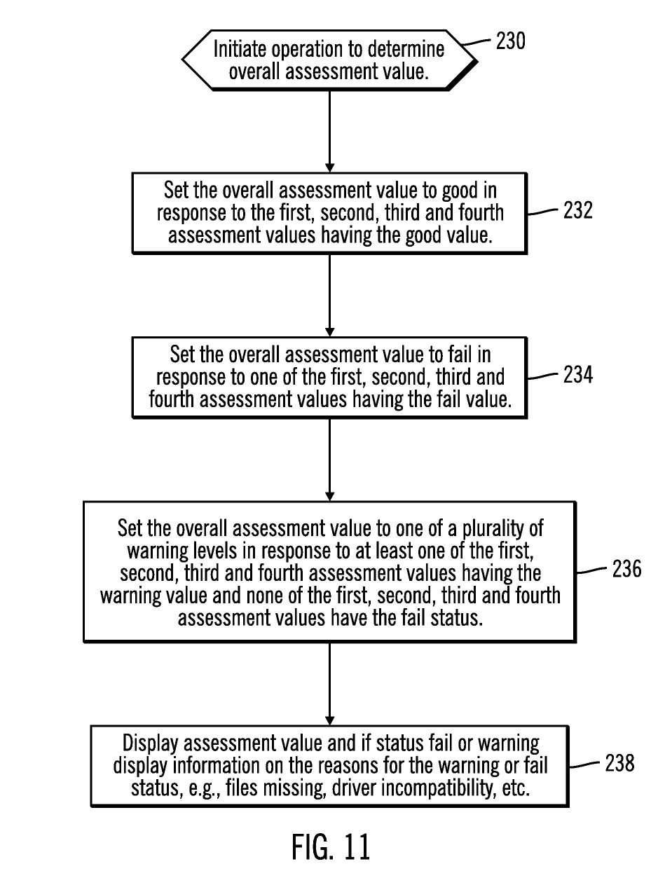

The backup assessor 30 then determines (at block 112) an overall assessment value for the selected backup image based on the determined first assessment value, second assessment value, third assessment value, and fourth assessment value. This overall assessment value may indicate that the selected backup image is good, a warning or fail. FIG. 11 provides further details on operations to determine the overall assessment value. The backup assessor 30 presents (at block 114) information on the overall assessment value to the user invoking the backup assessor 30 for the selected backup image 26 to use to ascertain whether to apply the selected backup image to the target computer system 10. If the presented information indicates a warning or fail status for the backup image 26, then additional information may be provided such as the files that are missing or problems that resulted in the warning or fail status. The user may then determine whether to proceed with the selected backup image 26 to recover the image represented by the selected backup image 26 to the target computer 10 or select another backup image to assess as a candidate for recovery.

In further embodiments, the backup assessor 30 may also provide meaningful information to the user, not just a backup assessment value, such as information on how to change policy or processes so that a better assessment can be achieved for future backups. For example, if the assessment indicated that files were missing because of a policy setting that dictated that files are only kept for 15 days but the user is trying to recover to a point-in-time that is 30 days old, the assessment information may instruct the user how to change the policy setting(s) such that the individual files can be retained for at least 30 days for future backups.

FIG. 7 illustrates an embodiment of operations performed by the backup assessor 30 to determine the first assessment value based on the include list 32 relevant to the selected backup image 26, i.e., relevant to the operating system 4 of the source computer system whose image is included in the selected backup image 26. Upon initiating (at block 130) the operation to determine the first assessment value, if (at block 132) the backup image 26 does not include all the system state files 90, then the first assessment value is set (at block 134) to fail. If (at block 132) all system state files specified in the include list 32 are in the selected backup° set 26, then the backup assessor 30 determines (at block 136) whether all the recovery metadata 94 in the include list 32 is included in the selected backup image 26. If so, then the backup assessor 30 determines (at block 140) whether all critical operating system files 92 are included in the backup image 26. If so, then the backup assessor 30 sets (at block 142) the first assessment value to good. If (from the no branch of block 134 or 138) not all the recovery metadata 94 nor critical operating system files 92 indicated in the include list 32 are included in the backup image 26, then the backup assessor 30 may set (at block 138) the first assessment value to warning or fail based on a number of recovery metadata 94 and critical operating system files 92 that are missing from the backup image 26. Alternatively, certain recovery metadata 94 or operating system files 92 may be more critical and thus their absence from the backup image 26 may result in a higher warning level than other files 92, 94. Further, missing recovery metadata 94 may result in a lower warning level than missing critical operating system files because the absence of missing recovery metadata 94 from a point-in-time backup image 26 may not be as problematic as missing critical operating system files 92.

FIG. 8 illustrates an embodiment of operations performed by the backup assessor 30 to determine the second assessment value based on the backup status of those system state files 90, critical operating system files 92, and recovery metadata 94 actually included in the backup image 26, i.e., how well those backups went. Upon initiating (at block 150) the operation to determine the second assessment value, the backup assessor 30 determines (at block 152) the backup status of the system state files, recovery metadata files, and critical operating system files backed-up in the backup image 26. The backup status may be determined by applying an error correction code to check if the file backed up is valid or other validation operation on the file. If (at block 154) not all the system state files 90 included in the backup image 26 were successfully backed-up, then the backup status for the system state files is set 9 at block 156) to fail and the second assessment value is set (at block 158) to fail.

If (at block 154) all the system state files included in the selected backup image 26 were successfully backed-up, then the backup status for the system state files is set (at block 160) to good. The backup status for the recovery metadata is set (at block 162) to good, warning or fail based on an amount of the backed-up recovery metadata that was successfully backed-up, e.g., the more that were not successfully backed-up, the higher the warning level. The backup assessor 30 further sets (at block 164) the backup status for the critical operating system files to good, warning or fail based on a number of recovery metadata files included in the backup being successfully backed-up.

If (at block 166) the backup statuses for the recovery metadata and critical operating system files in the backup image 26 are both good, then the second assessment value is set (at block 168) to good. Otherwise, the second assessment value is set (at block 170) to a warning level based on the warning level(s) and good status of the critical operating system files and recovery metadata. The warning level may be a sum or average or other computed value based on the warning levels of the critical operating system file and recovery metadata backup statuses.

In one implementation, the backup status of recovery metadata in only the selected backup image 26 may be considered, and not the backup statuses in any other previous incremental and full backup images 26 for the client computer 2 image being recovered. In an alternative embodiment, the backup statuses for recovery metadata as well as the critical operating system files and system state files in all the incremental and full backup images for the client image may be considered to determine the backup status.

FIG. 9 illustrates an embodiment of operations performed by the backup assessor 30 to determine the third assessment value based on whether the selected backup image 26 satisfies file retention policies applicable to the client computer 2 being backed-up.

File retention policies may indicate a number of days or number of versions to maintain for active files, inactive files, deleted files and non-deleted files. The purpose of the third assessment is to determine whether the file versions present at the time of the backup are likely to still be retained given factors such as retention policy applicable to the source computer system 2 subject to the backup, frequency of backups, etc. To the extent the backed-up files do not satisfy this assessment, then this factor could reduce the likelihood of a successful recovery operation. Upon initiating the operation to estimate the third assessment value, the backup assessor 30 determines (at block 192) from a plurality of retention policies applicable to files included in the source computer system 2 a most restrictive retention policy. To determine the most restrictive retention policy if there are multiple policies, the backup assessor may convert retention policies in different formats to a common format. For instance, if some retention policies are expressed in a “days to retain” retention unit and others expressed in a “number of versions” to retain retention unit, then the backup assessor may convert the “days to retain” retention policy to a “number of versions” to retain by multiplying the “days to retain” policy by a number of backups per day. The backup assessor 30 processes (at block 194) the point-in-time 48 at which the selected backup image 26 was created to express the selected backup image 26 in the retention term units of the most restrictive policy. For instance, if the most restrictive retention term policy is expressed in a number of versions, then the backup assessor 30 determines the number of days from a current time to the point-in-time 48 of the selected backup image, then multiplies the determined number of days times the number of backups to determine the version number of the backup image 26, so that the backup image and the retention policy are expressed in the same retention term unit. If (at block 196) the selected backup image 26 satisfies the most restrictive retention policy, e.g., the estimated backup image version number is less than the version number of the most restrictive retention policy, then the third assessment value is set (at block 198) to good. Otherwise, the third assessment value is set (at block 200) to warning.

Determining whether a selected backup image satisfies a most restrictive retention policy allows a further estimation as to whether the restoration of the selected backup is likely to succeed because a backup image having files that satisfy the retention policy requirements have a greater likelihood of restoring the target computer system 10 to an operational state. The described operations use an estimation technique assuming that the maximum number of revisions that could have occurred within the backup image based on an age of the backup image and the number of back-ups per day without having to consider individually whether each file in the backup image satisfies each retention policy requirement, which could be very computationally expensive. In an alternative embodiment, the assessment of the retention policy compliance may be performed by considering whether each file in the selected backup image 26, and files in the incremental and full backups, satisfies the retention policies applicable to the source client computer system 2.

Further details on how to determine the third assessment value based on a most restrictive retention policy is disclosed in the commonly assigned patent application titled “DETERMINING WHETHER A SELECTED BACKUP IMAGE SATISFIES A RETENTION POLICY”, by Surya K. GHATTY, James P. SMITH, Peter B. SYMONDS, and William R. YONKER, having Attorney Docket No SJO920110078US1, filed on the same date hereof, which patent application is incorporated herein by reference in its entirety.

FIG. 10 illustrates an embodiment of operations performed by the backup assessor 30 to perform introspection to determine the fourth assessment value based on the compatibility of the computational resources of the source client computer 2 and target computer system 10. Upon initiating (at block 200) the operations to determine the fourth assessment value, the backup assessor 30 determines (at block 202) whether the backup image 26 includes recovery metadata for devices and device drivers in the source computer system. If not, the fourth assessment value is set (at block 208) to warning. If (at block 202) the backup image includes recovery metadata providing information on devices and device drivers at the source computer 2, then the backup assessor 30 gathers (at block 204) information on the devices and device drivers included in the target computer system 10, such as by querying the target computer system 10 over the network 12 or accessing the information from a data store, such as the backup database 18. The backup assessor 30 then determines (at block 206) whether there are a threshold level or number of compatibility issues with respect to the compatibility of the devices and the device drivers in the target computer system 10 with the devices and the device drivers in the source computer system 2 from which the image was created. If (at block 206) there are a threshold number of compatibility issues or if the backup image does not include recovery metadata (from the no branch of block 202), then the fourth assessment value is set (at block 208) to warning.

If (at block 206) there are not a threshold number of device and device driver compatibility issues, then the backup assessor 30 determines (at block 210) computational resources at the target computer system 10, such as available storage, processor speed, memory, etc. If (at block 210) the computational resources of the target computer system 10 are sufficient to execute the image of the source computer system 2, then the fourth assessment value is set (at block 212) to good. Otherwise, if the target computational resources are not sufficient, the fourth assessment value is set (at block 214) to fail.

During the recovery, the backup server 16 may perform device driver reconciliations to avoid overwriting existing drivers in the target computer system 10 with device drivers from the source computer image that would be incompatible with the target system 10 hardware. Further, the introspection to determine device and device driver compatibility may also apply to embodiments where the image is recovered to the source computer and new hardware has been installed on the source computer. Further, the introspection to determine device and device driver compatibility can be applied regardless of whether the source or destination systems are physical or virtual. In other words, the source/destination combinations may be physical to virtual, physical to physical, virtual to virtual, or virtual to physical. To accomplish this device driver introspection task, the information needs to be collected on a regular basis with the data backups, and the information needs to be available to the backup assessor 30 during image recovery.

FIG. 11 illustrates an embodiment of operations performed by the backup assessor 30 to process the first, second, third, and fourth assessment values to determine an overall assessment value for the selected backup image 26. Upon initiating (at block 230) the operation to determine the overall assessment, the backup assessor 30 sets (at block 232) the overall assessment value to good in response to the first, second, third and fourth assessment values having the good value. The overall assessment value is set (at block 234) to fail in response to one of the first, second, third and fourth assessment values having the fail value. The overall assessment value is set (at block 236) to one of a plurality of warning levels in response to at least one of the first, second, third and fourth assessment values having the warning value and none of the first, second, third and fourth assessment values have the fail status.

In one embodiment where the warning levels of the assessment values comprise numbers, the overall assessment warning level may be calculated by summing the warning levels of the first, second, third and fourth assessment values. In a further embodiment, each of the first, second, third and fourth assessment values may be associated with a different weighted warning value, and the overall assessment value is calculated by summing the weighted warning values of the first, second, third and fourth assessment having warning status. In this way, certain factors or assessment values may be given greater weight than others, for instance the presence in the selected backup image 26 of files on the include list 32 may be more important or given greater warning weight than whether the backup image satisfies a retention policy, the backup status of the backed-up files from the include list or the compatibility of the source and target device drivers and devices.

After calculating the overall assessment value, the backup assessor 30 displays (at block 238) the assessment value and if status is fail or warning, then the backup assessor 30 may further display information on the reasons for the warning or fail status, e.g., files missing, driver incompatibility, etc. The user invoking the backup assessor 30 may use the displayed assessment value and information to determine whether to initiate a recovery from the selected backup image 26 to the target computer, which would include restoring all files saved as part of the selected backup image 26, any incremental backup images preceding the selected backup image, and the full backup image.

Described embodiments provide techniques for assessing the likelihood that a selected backup image will result in a successful recovery operation based on a plurality of factors, such as whether the backup image includes critical files and recovery metadata, the backup status of those backed-up critical files and recovery metadata, whether the selected backup image satisfies a retention policy (e.g., to determine whether the appropriate file versions from the selected point-in-time still exist given the retention policies and other factors such as frequency of file changes, frequency of backups, etc.), and whether the target computer 10 to which the image maintained in the backup image is applied has computational resources and device drivers compatible with those in the source computer from which the image was generated. Because a recovery operation can be a very time consuming process, described embodiments provide the administrator or user with information to allow them to assess the likelihood of success of a particular backup image for an image they are considering whether to recover.

The described operations may be implemented as a method, apparatus or computer program product using standard programming and/or engineering techniques to produce software, firmware, hardware, or any combination thereof. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or

Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

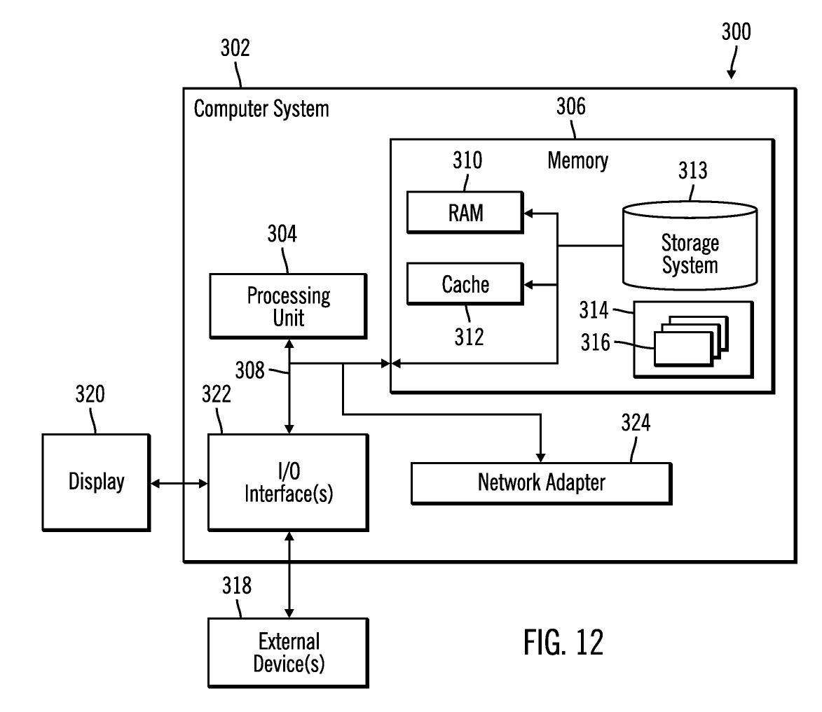

The program components of the computer 2, server 14, and target computer 10 may be implemented as one or more program modules in one or more computer systems, such as the computer system 302 shown in FIG. 12. Computer system/server 302 may be described in the general context of computer system executable instructions, such as program modules, being executed by a computer system. Generally, program modules may include routines, programs, objects, components, logic, data structures, and so on that perform particular tasks or implement particular abstract data types. Computer system/server 302 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, the computer system/server 302 is shown in the form of a general-purpose computing device. The components of computer system/server 302 may include, but are not limited to, one or more processors or processing units 304, a system memory 306, and a bus 308 that couples various system components including system memory 306 to processor 304. Bus 308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 302 typically includes a variety of computer system readable media. Such media may be any available media that is accessible by computer system/server 302, and it includes both volatile and non-volatile media, removable and non-removable media.

System memory 306 can include computer system readable media in the form of volatile memory, such as random access memory (RAM) 310 and/or cache memory 312. Computer system/server 302 may further include other removable/non-removable, volatile/non-volatile computer system storage media. By way of example only, storage system 313 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 308 by one or more data media interfaces. As will be further depicted and described below, memory 306 may include at least one program product having a set (e.g., at least one) of program modules that are configured to carry out the functions of embodiments of the invention.

Program/utility 314, having a set (at least one) of program modules 316, may be stored in memory 306 by way of example, and not limitation, as well as an operating system, one or more application programs, other program modules, and program data. Each of the operating system, one or more application programs, other program modules, and program data or some combination thereof, may include an implementation of a networking environment. The components of the computer 2 may be implemented as program modules 316 which generally carry out the functions and/or methodologies of embodiments of the invention as described herein. The components of the backup server 16, the backup database 18, and the backup storage 24 may be implemented in one or more computer systems 302, where if they are implemented in multiple computer systems 302, then the computer systems may communicate over a network.

Computer system/server 302 may also communicate with one or more external devices 318 such as a keyboard, a pointing device, a display 320, etc.; one or more devices that enable a user to interact with computer system/server 12; and/or any devices (e.g., network card, modem, etc.) that enable computer system/server 302 to communicate with one or more other computing devices. Such communication can occur via Input/Output (I/O) interfaces 322. Still yet, computer system/server 302 can communicate with one or more networks such as a local area network (LAN), a general wide area network (WAN), and/or a public network (e.g., the Internet) via network adapter 324. As depicted, network adapter 324 communicates with the other components of computer system/server 302 via bus 308. It should be understood that although not shown, other hardware and/or software components could be used in conjunction with computer system/server 302. Examples, include, but are not limited to: microcode, device drivers, redundant processing units, external disk drive arrays, RAID systems, tape drives, and data archival storage systems, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for assessing a backup image comprising a backup of a source computer system to recover to a target computer system, wherein the computer program product comprises a computer readable storage medium having computer readable program code embodied therein that executes to perform operations, the operations comprising:
selecting a point-in-time backup image from a plurality of backup images taken of an image on the source computer system, wherein the selected backup is to be applied to the target computer system;
determining a first assessment value associated with an extent to which critical files of the image from the source computer system and recovery metadata providing configuration information on the source computer system are included in the selected backup based on an include list of critical files and recovery metadata to include in the backup;
determining a second assessment value comprising a backup status of the critical files and the recovery metadata included in the selected backup;
determining a third assessment value indicative of an extent to which the selected backup satisfies requirements of a retention policy in effect when the backup images were created;
determining a fourth assessment value indicative of an extent to which computational resources and device drivers in the target computer system are compatible with computational resources and device drivers on the source computer system;
determining an overall assessment value for the selected backup image based on the determined first assessment value, second assessment value, third assessment value, and fourth assessment value; and
presenting information on the overall assessment value for use in determining whether to apply the image stored in the selected backup image to the target computer system.

2. The computer program product of claim 1, wherein determining the first assessment value comprises:
accessing an include list indicating system state files, critical operating system files, and recovery metadata to include in the backup of the source computer system image;
determining from the include list whether all the system state files are included in the selected backup image;
determining from the include list critical operating system files included in the backup image;
determining from the include list recovery metadata, providing information about the source computer system required to perform the backup, included in the backup image; and
determining the first assessment value based on whether all system state files are included in the backup image, a number of the critical operating system files included in the backup, and an amount of the backup metadata included in the backup image.

3. The computer program product of claim 2, wherein the first assessment value is set to:
good in response to determining that all of the system state files, the critical operating system files, and the recovery metadata indicated in the include list are included in the selected backup image;
fail in response to determining that not all of the system state files in the include list are included in the selected backup image; and
warning or fail based on the determined critical operating system files and the recovery metadata from the include list included in the backup image when the backup image includes all of the system state files.

4. The computer program product of claim 3, wherein the warning for the recovery metadata and the critical operating system files comprises one of a plurality of warning values based on a number of the recovery metadata and the critical operating system files included in the backup image.

5. The computer program product of claim 1, wherein the determining of the second assessment value comprises:
determining a backup status of system state files, recovery metadata, and critical operating system files backed-up in the selected backup image;
setting the backup status for the system state files to good in response to determining that all the system state files included in the backup are successfully backed up;
setting the backup status for the system state files to fail in response to determining that one the system state files included in the backup was not successfully backed-up;
setting the backup status for the recovery metadata to good, warning or fail based on an amount of the recovery metadata included in the backup being successfully backed-up;
setting the backup status for the critical operating system files to good, warning or fail based on a number of the critical operating system files included in the backup being successfully backed-up; and
wherein the second assessment value is based on the backup status for the system state files, the recovery metadata, and the critical operating system files.

6. The computer program product of claim 5, wherein determining the second assessment value comprises setting the second assessment value to:
good in response to determining that backup statuses for the recovery metadata, the system state files, and the critical operating system files are all good;
fail in response to determining that one of the backup statuses for the recovery metadata, the system state files, and the critical operating system files is fail; and
warning in response to determining that the backup statuses for at least one of the recovery metadata and the critical operating system files is warning and that no backup status for the recovery metadata, the system state files, and the critical operating system files is fail.

7. The computer program product of claim 1, wherein the determining of the third assessment value comprises:
determining from a plurality of retention policies applicable to files included in the source computer system a most restrictive retention policy;
determining whether the selected backup image satisfies the most restrictive retention policy;
setting the third assessment value to good in response to determining that the selected backup image satisfies the most restrictive retention policy; and
setting the third assessment value to warning in response to determining that the selected backup image does not satisfy the most restrictive retention policy.

8. The computer program product of claim 1, wherein determining the fourth assessment value comprises:
determining whether the backup image includes metadata for devices and device drivers;
determining devices and device drivers included in the target computer system;
determining whether there are compatibility issues with respect to the determined devices and device drivers in the target computer system and the devices and the device drivers identified in the backup metadata for the source computer system;
setting the fourth assessment value to warning (1) in response to determining that there are a threshold level of compatibility issues with respect to the compatibility of the devices and the device drivers in the target computer system with the devices and the device drivers in the source computer system subject to the backup or (2) in response to the backup image not including the recovery metadata for the devices and the device drivers; and
setting the fourth assessment value to good in response to determining that there are a minimal number of compatibility issues.

9. The computer program product of claim 8, wherein determining the fourth assessment value comprises:
determining computational resources of the target computer system in response to determining that there are no compatibility issues;
determine whether the computational resources of the target computer system are sufficient to execute the image of the source computer system, wherein the fourth assessment value is set to good in response to additionally determining that the computational resources of the target computer system are sufficient; and
setting the fourth assessment value to fail in response to determining that the computational resources of the target computer system are not sufficient.

10. The computer program product of claim 1, wherein the first, second, third, and fourth assessment values have values that are a member of a set of values comprising good, fail, and warning, and wherein determining the overall assessment value comprises:
setting the overall assessment value to good in response to the first, second, third and fourth assessment values having the good value;
setting the overall assessment value to fail in response to one of the first, second, third and fourth assessment values having the fail value;
setting the overall assessment value to one of a plurality of warning levels in response to at least one of the first, second, third and fourth assessment values having the warning value and none of the first, second, third and fourth assessment values having the fail status; and
displaying each factor associated with the at least one of the first, second, third and fourth assessment values having the warning value or fail to provide information on a reason for the warning or fail.

11. The computer program product of claim 1, wherein the presented information for provides information on how the user may change a backup policy and processes to obtain better assessment results.

12. A method for assessing a backup image comprising a backup of a source computer system to recover to a target computer system, comprising:
selecting a point-in-time backup image from a plurality of backup images in a computer readable storage taken of an image on the source computer system, wherein the selected backup is to be applied to the target computer system;
determining a first assessment value associated with an extent to which critical files of the image from the source computer system and recovery metadata providing configuration information on the source computer system are included in the selected backup based on an include list of critical files and recovery metadata to include in the backup;
determining a second assessment value comprising a backup status of the critical files and the recovery metadata included in the selected backup;
determining a third assessment value indicative of an extent to which the selected backup satisfies requirements of a retention policy in effect when the backup images were created;
determining a fourth assessment value indicative of an extent to which computational resources and device drivers in the target computer system are compatible with computational resources and device drivers on the source computer system;
determining an overall assessment value for the selected backup image based on the determined first assessment value, second assessment value, third assessment value, and fourth assessment value; and
presenting information on the overall assessment value for use in determining whether to apply the image stored in the selected backup image to the target computer system.

13. The method of claim 12, wherein determining the first assessment value comprises:
accessing an include list indicating system state files, critical operating system files, and recovery metadata to include in the backup of the source computer system image;
determining from the include list whether all the system state files are included in the selected backup image;
determining from the include list critical operating system files included in the backup image;
determining from the include list recovery metadata, providing information about the source computer system required to perform the backup, included in the backup image; and
determining the first assessment value based on whether all system state files are included in the backup image, a number of the critical operating system files included in the backup, and an amount of the backup metadata included in the backup image.

14. The method of claim 13, wherein the first assessment value is set to:
good in response to determining that all of the system state files, the critical operating system files, and the recovery metadata indicated in the include list are included in the selected backup image;
fail in response to determining that not all of the system state files in the include list are included in the selected backup image; and
warning or fail based on the determined critical operating system files and the recovery metadata from the include list included in the backup image when the backup image includes all of the system state files.

15. The method of claim 12, wherein the determining of the second assessment value comprises:
determining a backup status of system state files, recovery metadata, and critical operating system files backed-up in the selected backup image;
setting the backup status for the system state files to good in response to determining that all the system state files included in the backup are successfully backed up;
setting the backup status for the system state files to fail in response to determining that one the system state files included in the backup was not successfully backed-up;
setting the backup status for the recovery metadata to good, warning or fail based on an amount of the recovery metadata included in the backup being successfully backed-up;
setting the backup status for the critical operating system files to good, warning or fail based on a number of the critical operating system files included in the backup being successfully backed-up; and
wherein the second assessment value is based on the backup status for the system state files, the recovery metadata, and the critical operating system files.

16. The method of claim 12, wherein the determining of the third assessment value comprises:
determining from a plurality of retention policies applicable to files included in the source computer system a most restrictive retention policy;
determining whether the selected backup image satisfies the most restrictive retention policy;
setting the third assessment value to good in response to determining that the selected backup image satisfies the most restrictive retention policy; and
setting the third assessment value to warning in response to determining that the selected backup image does not satisfy the most restrictive retention policy.

17. The method of claim 12, wherein determining the fourth assessment value comprises:
determining whether the backup image includes metadata for devices and device drivers;
determining devices and device drivers included in the target computer system;
determining whether there are compatibility issues with respect to the determined devices and device drivers in the target computer system and the devices and the device drivers identified in the backup metadata for the source computer system;
setting the fourth assessment value to warning (1) in response to determining that there are a threshold level of compatibility issues with respect to the compatibility of the devices and the device drivers in the target computer system with the devices and the device drivers in the source computer system subject to the backup or (2) in response to the backup image not including the recovery metadata for the devices and the device drivers; and
setting the fourth assessment value to good in response to determining that there are a minimal number of compatibility issues.

18. The method of claim 12, wherein the first, second, third, and fourth assessment values have values that are a member of a set of values comprising good, fail, and warning, and wherein determining the overall assessment value comprises:
setting the overall assessment value to good in response to the first, second, third and fourth assessment values having the good value;
setting the overall assessment value to fail in response to one of the first, second, third and fourth assessment values having the fail value;
setting the overall assessment value to one of a plurality of warning levels in response to at least one of the first, second, third and fourth assessment values having the warning value and none of the first, second, third and fourth assessment values having the fail status; and
displaying each factor associated with the at least one of the first, second, third and fourth assessment values having the warning value or fail to provide information on a reason for the warning or fail.

19. A system for assessing a backup image comprising a backup of a source computer system to recover to a target computer system, comprising:
a processor; and
a computer readable storage medium including program code executed by the processor to perform operations, the operations comprising:
selecting a point-in-time backup image from a plurality of backup images in a computer readable storage taken of an image on the source computer system, wherein the selected backup is to be applied to the target computer system;
determining a first assessment value associated with an extent to which critical files of the image from the source computer system and recovery metadata providing configuration information on the source computer system are included in the selected backup based on an include list of critical files and recovery metadata to include in the backup;
determining a second assessment value comprising a backup status of the critical files and the recovery metadata included in the selected backup;
determining a third assessment value indicative of an extent to which the selected backup satisfies requirements of a retention policy in effect when the backup images were created;
determining a fourth assessment value indicative of an extent to which computational resources and device drivers in the target computer system are compatible with computational resources and device drivers on the source computer system;
determining an overall assessment value for the selected backup image based on the determined first assessment value, second assessment value, third assessment value, and fourth assessment value; and
presenting information on the overall assessment value for use in determining whether to apply the image stored in the selected backup image to the target computer system.

20. The system of claim 19, wherein determining the first assessment value comprises:
accessing an include list indicating system state files, critical operating system files, and recovery metadata to include in the backup of the source computer system image;
determining from the include list whether all the system state files are included in the selected backup image;
determining from the include list critical operating system files included in the backup image;
determining from the include list recovery metadata, providing information about the source computer system required to perform the backup, included in the backup image; and
determining the first assessment value based on whether all system state files are included in the backup image, a number of the critical operating system files included in the backup, and an amount of the backup metadata included in the backup image.

21. The system of claim 20, wherein the first assessment value is set to:
good in response to determining that all of the system state files, the critical operating system files, and the recovery metadata indicated in the include list are included in the selected backup image;
fail in response to determining that not all of the system state files in the include list are included in the selected backup image; and
warning or fail based on the determined critical operating system files and the recovery metadata from the include list included in the backup image when the backup image includes all of the system state files.

22. The system of claim 19, wherein the determining of the second assessment value comprises:
determining a backup status of system state files, recovery metadata, and critical operating system files backed-up in the selected backup image;
setting the backup status for the system state files to good in response to determining that all the system state files included in the backup are successfully backed up;
setting the backup status for the system state files to fail in response to determining that one the system state files included in the backup was not successfully backed-up;
setting the backup status for the recovery metadata to good, warning or fail based on an amount of the recovery metadata included in the backup being successfully backed-up;
setting the backup status for the critical operating system files to good, warning or fail based on a number of the critical operating system files included in the backup being successfully backed-up; and
wherein the second assessment value is based on the backup status for the system state files, the recovery metadata, and the critical operating system files.

23. The system of claim 19, wherein the determining of the third assessment value comprises:
determining from a plurality of retention policies applicable to files included in the source computer system a most restrictive retention policy;
determining whether the selected backup image satisfies the most restrictive retention policy;
setting the third assessment value to good in response to determining that the selected backup image satisfies the most restrictive retention policy; and
setting the third assessment value to warning in response to determining that the selected backup image does not satisfy the most restrictive retention policy.

24. The system of claim 19, wherein determining the fourth assessment value comprises:
determining whether the backup image includes metadata for devices and device drivers;
determining devices and device drivers included in the target computer system;
determining whether there are compatibility issues with respect to the determined devices and device drivers in the target computer system and the devices and the device drivers identified in the backup metadata for the source computer system;
setting the fourth assessment value to warning (1) in response to determining that there are a threshold level of compatibility issues with respect to the compatibility of the devices and the device drivers in the target computer system with the devices and the device drivers in the source computer system subject to the backup or (2) in response to the backup image not including the recovery metadata for the devices and the device drivers; and
setting the fourth assessment value to good in response to determining that there are a minimal number of compatibility issues.

25. The system of claim 19, wherein the first, second, third, and fourth assessment values have values that are a member of a set of values comprising good, fail, and warning, and wherein determining the overall assessment value comprises:
setting the overall assessment value to good in response to the first, second, third and fourth assessment values having the good value;
setting the overall assessment value to fail in response to one of the first, second, third and fourth assessment values having the fail value;
setting the overall assessment value to one of a plurality of warning levels in response to at least one of the first, second, third and fourth assessment values having the warning value and none of the first, second, third and fourth assessment values having the fail status; and
displaying each factor associated with the at least one of the first, second, third and fourth assessment values having the warning value or fail to provide information on a reason for the warning or fail.
